(19) United States
(12) Patent Application Publication
(10) Pub. No.: US 2023/0292760 A1
(43) Pub. Date: Sep. 21, 2023

(54) AGRICULTURAL COMPOSITIONS AND RELATED METHODS

(71) Applicant: SETATECH USA, INC., Homestead, FL (US)

(72) Inventors: Blair BLACKER, Homestead, FL (US); Lisa CHEN, Homestead, FL (US); Richard DEHLINGER, Homestead, FL (US)

(21) Appl. No.: 18/122,491

(22) Filed: Mar. 16, 2023

Related U.S. Application Data
(60) Provisional application No. 63/321,082, filed on Mar. 17, 2022.

(51) Int. Cl. A01N 63/10

(52) U.S. Cl. CPC A01N 63/10

(57) ABSTRACT

Agricultural compositions are provided that include at least one keratin protein and at least one carrier. The agricultural compositions provide an environmentally friendly and biodegradable alternative to traditional chemicals and biologicals. The agricultural compositions are suitable for a variety of uses including, but not limited to, increasing plant height and biomass, increasing plant, leaf, increasing stem and root weight, and increasing crop or plant yield compared to application of traditional chemicals or plant growth regulators.

### CROSS-REFERENCE TO RELATED APPLICATIONS

The present application claims priority to U.S. provisional application number 63/321,082 filed Mar.−17, 2022.

### BACKGROUND OF THE DISCLOSURE

For millennia, man has endeavored to increase agricultural production and maintain the health of various plants and crops we depend upon for survival or otherwise enjoy for hobby. Today, agricultural and horticultural science has progressed to the point that optimal production is possible using far fewer resources than was previously required. Today, a variety of chemicals including significant amounts of chemical fertilizers may be required to obtain what is viewed as optimal plant health. Such chemicals are generally used for a wide variety of purposes including controlling weeds, retaining water, adding nutrients, and controlling pests such as insects, fungi and bacteria. Chemical fertilizers are usually suspended in liquid and can be added to the irrigation field systems or directly applied as pellets to the soil. Over time, these fertilizers can damage the soil, requiring additional amendments to stabilize the soil and maintain yield.

### SUMMARY OF THE DISCLOSURE

The present disclosure is directed to agricultural compositions that have the ability to replace traditional chemicals and deliver and all-natural and sustainable alternative without sacrificing results typically associated with traditional chemicals. The agricultural compositions provided include at least one keratin protein and at least one carrier. The keratin protein is derived from a sustainable keratin protein source and, thus, provides an easy, fast and cost-efficient solutions to growing healthier plants and increasing agricultural production. The agricultural compositions are useful in a variety of settings including home gardening as well as large or small scale farms (i.e., traditional agriculture).

The agricultural compositions provided herein stimulate and increase healthy plant growth and improve or enhance the health and performance of agricultural, home and garden plants. The agricultural compositions provided herein are also useful to increase stem width, increase root length and increase final harvest weight. The agricultural compositions as provided herein are also suitable for promoting seed germination, promoting water retention, promoting spot growth on existing plantings, controlling weeds, and deterring pests.

According to one aspect, an agricultural composition is provided that includes at least one keratin protein that, in turn, includes from about 5.0% w/w to about 20.0% w/w nitrogen, from about 0.01% w/w to about 5.0% w/w phosphorus, and from about 0.1% w/w to about 10.0% w/w potassium. According to one embodiment, an agricultural composition is provided that further includes at least one carrier. According to one embodiment, the keratin protein is isolated from human hair. According to one embodiment, the carrier includes water. According to one embodiment, the agricultural composition includes from about 5.0% w/w to about 25.0% w/w of the at least one keratin protein and from about 75% w/w to about 95% w/w of the at least one carrier. According to one embodiment, the at least one keratin protein comprises from about 10% w/w to about 20% w/w nitrogen. According to one embodiment, the agricultural composition increases plant growth by 15% upon application to a plant.

According to another aspect, an agricultural device is provided that includes an agricultural composition as provided herein as well as a multi-function horticultural device. The agricultural composition includes at least one keratin protein that, in turn, includes from about 5% w/w to about 20% nitrogen, from about 0.01% w/w to about 5.0% w/w phosphorus, and from about 0.1% w/w potassium to about 10.0% w/w potassium. The agricultural composition further includes at least one carrier. The multi-function horticultural device includes a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous. According to one embodiment, the multi-function horticultural device includes at least one natural fiber from the group including human hair, animal hair, coconut fiber, seaweed, kelp, cotton, corn silk and peat moss. According to one embodiment, the multi-function horticultural device further comprises a plurality of man-made fibers. According to one embodiment, the agricultural composition includes from about 5.0% w/w to about 25.0% w/w of the at least one keratin protein, and from about 75% w/w to about 95% w/w of the at least one carrier.

According to one aspect, a method for stimulating root development of a plant is provided. The method includes the step of applying the agricultural composition as provided herein to a surface of the plant, surrounding soil, turf, seed, or a combination thereof. According to one embodiment, the method further includes the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.

According to one aspect, a method of improving the quality or health of at least one target plant is provided. The method includes the step of applying the agricultural composition as provided herein to a surface of the at least one plant, the surrounding soil, turf, seed, or a combination thereof. According to one embodiment, the method further includes the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.

According to one aspect, a method of increasing crop yield of at least one plant. The method includes the step of applying the agricultural composition as provided herein to the surface of the at least one plant, the surrounding soil, turf, seed, or a combination thereof. According to one embodiment, the method further includes the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.

According to one aspect, a method of deterring pests from at least one plant is provided. The method includes the step of applying the agricultural composition as provided herein to the surface of the at least one plant, the surrounding soil, turf, seed, or a combination thereof. According to one embodiment, the method further includes the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.

According to one aspect, a method of increasing moisture retention for at least one plant is provided. The method includes the step of applying the agricultural composition of as provided herein to the surface of the at least one plant, the surrounding soil, turf, seed, or a combination thereof. According to one embodiment, the method of further includes the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.

The summary of the disclosure is provided as a general introduction to some of the embodiments of the disclosure and is not intended to be limiting. Additional example embodiments including variations and alternative configurations of the disclosure are provided herein.

### DETAILED DESCRIPTION OF THE DISCLOSURE

One or more aspects and embodiments may be incorporated in a different embodiment although not specifically described. That is, all aspects and embodiments can be combined in any way or combination. When referring to the compounds disclosed herein, the following terms have the following meanings unless indicated otherwise. The following definitions are meant to clarify, but not limit, the terms defined. If a particular term used herein is not specifically defined, such term should not be considered indefinite. Rather, terms are used within their accepted meanings.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The use of “a” or “an” are employed to describe elements and components described herein. This is done merely for convenience and to give a general sense of the scope of the disclosure. This description should be read to include one or at least one and the singular also includes the plural unless it is obvious that it is meant otherwise.

As used herein, the terms “agriculture” and “agricultural” refer to the science, art, business or practice of farming and cultivation (both large and small scales) and further refers to horticulture which, in turn, includes the science, art, business or practice of growing plants used by people for various purposes included food, medicine or hobby.

“Optional” or “optionally” means that the subsequently described event or circumstance may or may not occur, and that the description includes instances where the event or circumstance occurs and instances where it does not.

As used herein, the term “keratin protein(s)” as used herein collectively refers to one or more of: naturally occurring keratin, reduced keratin, oxidized keratin, S-sulfonated keratin, or a combination thereof. This term also refers to the extracted keratin protein derivatives that are produced by oxidative and/or reductive treatment of a keratin protein source. Types of keratin proteins, include but not limited to keratose, alpha-keratose, gamma-keratose, kerateines, alpha-kerateine, or gamma-kerateine. Soluble keratin proteins can be extracted from keratin protein sources by oxidation or reduction using methods known in the art. If an oxidative treatment is used, the resulting keratin proteins are referred to as “keratoses.” If a reductive treatment is used, the resulting keratin proteins are referred to as “kerateines.”

The term “effective amount,” as used herein, means an amount of an agricultural composition sufficient to attain the intended result.

### Overview

Agricultural compositions are provided that include at least one keratin protein and at least one carrier. The agricultural compositions provide an environmentally friendly and biodegradable alternative to traditional chemicals and biologicals. The agricultural compositions are suitable for a variety of uses including, but not limited to, increasing plant height and biomass, increasing plant, leaf, increasing stem and root weight, and increasing crop or plant yield compared to application of traditional chemicals or plant growth regulators. According to one embodiment, the agricultural compositions as provided herein are suitable for improving the number, size and quality of the crop grown from the plant, such as fruit, flowers, legumes or vegetables. According to one embodiment, the agricultural compositions as provided herein are suitable for promoting seed germination, promoting water retention, promoting spot growth on existing plantings, controlling weeds, and deterring pests. According to one embodiment, the agricultural compositions as provided herein may serve simultaneously as both an active and passive fertilizer as well as a herbicide. According to one embodiment, the agricultural compositions as provided herein may act as or contribute to a weed barrier.

### Keratin Proteins

The agricultural compositions provided herein include at least one keratin protein. According to one embodiment, the keratin protein is extracted from a keratin source such as, for example, human hair. Other suitable sources of keratin protein include animal sources such as feathers, wool, fur, horns, hooves, or beaks. According to one embodiment, the keratin protein is alpha-keratose, beta-keratose, gamma-keratose, alpha-kerateine, beta kerateine, gamma-kerateine, or a combination thereof. According to one embodiment, the keratin proteins as provided herein are substantially or completely soluble in water.

According to one embodiment, the agricultural compositions provided herein include at least one alpha keratin protein. Alpha keratin proteins includes the keratin protein that is a large, spring-shaped protein. The alpha keratin protein may vary in peak average molecular weight (Mp) but typically falls in a range of from about 60 Da to about 6.2 MDa.

The percentage of the at least one keratin protein in the agricultural compositions may vary. According to one embodiment, the agricultural composition includes at least about 0.1% w/w of at least one keratin protein. According to one embodiment, the agricultural composition includes at least about 0.5% w/w of at least one keratin protein. According to one embodiment, the agricultural composition includes at least about 1.0% w/w of at least one keratin protein. According to one embodiment, the agricultural composition includes at least about 2.0% w/w of at least one keratin protein. According to one embodiment, the agricultural composition includes at least about 3.0% w/w of at least one keratin protein. According to one embodiment, the agricultural composition includes at least about 4.0% w/w of at least one keratin protein. According to one embodiment, the agricultural composition includes at least about 5.0% w/w of at least one keratin protein. According to one embodiment, the agricultural composition includes at least about 6.0% w/w of at least one keratin protein. According to one embodiment, the agricultural composition includes at least about 7.0% w/w of at least one keratin protein. According to one embodiment, the agricultural composition includes at least about 8.0% w/w of at least one keratin protein. According to one embodiment, the agricultural composition includes at least about 9.0% w/w of at least one keratin protein. According to one embodiment, the agricultural composition includes at least about 10.0% w/w of at least one keratin protein. According to one embodiment, the agricultural composition includes at least about 11.0% w/w of at least one keratin protein. According to one embodiment, the agricultural composition includes at least about 12.0% w/w of at least one keratin protein. According to one embodiment, the agricultural composition includes at least about 13.0% w/w of at least one keratin protein. According to one embodiment, the agricultural composition includes at least about 14.0% w/w of at least one keratin protein. According to one embodiment, the agricultural composition includes at least about 15.0% w/w of at least one keratin protein. According to one embodiment, the agricultural composition includes at least about 16.0% w/w of at least one keratin protein. According to one embodiment, the agricultural composition includes at least about 17.0% w/w of at least one keratin protein. According to one embodiment, the agricultural composition includes at least about 18.0% w/w of at least one keratin protein. According to one embodiment, the agricultural composition includes at least about 19.0% w/w of at least one keratin protein. According to one embodiment, the agricultural composition includes at least about 20.0% w/w of at least one keratin protein. According to one embodiment, the agricultural composition includes at least about 21.0% w/w of at least one keratin protein. According to one embodiment, the agricultural composition includes at least about 22.0% w/w of at least one keratin protein. According to one embodiment, the agricultural composition includes at least about 23.0% w/w of at least one keratin protein. According to one embodiment, the agricultural composition includes at least about 24.0% w/w of at least one keratin protein. According to one embodiment, the agricultural composition includes at least about 25.0% w/w of at least one keratin protein.

According to one embodiment, the agricultural composition includes at least about 0.1% w/w to about 40.0% w/w of at least one keratin protein. According to one embodiment, the agricultural composition includes at least about 1.0% w/w to about 35.0% w/w of at least one keratin protein. According to one embodiment, the agricultural composition includes at least about 5.0% w/w to about 25.0% w/w of at least one keratin protein.

According to one embodiment, the keratin protein includes one or more elements suitable for agricultural use or needs. According to one embodiment, the keratin protein includes one or more element such as, for example, nitrogen, phosphorus, potassium, calcium, magnesium, sulfur, boron, chlorine, iron, manganese, zinc, copper, molybdenum, or nickel.

According to one embodiment, the keratin protein includes at least about 1.0% w/w nitrogen. According to one embodiment, the keratin protein includes at least about 2.0% w/w nitrogen. According to one embodiment, the keratin protein includes at least about 4.0% w/w nitrogen. According to one embodiment, the keratin protein includes at least about 6.0% w/w nitrogen. According to one embodiment, the keratin protein includes at least about 8.0% w/w nitrogen. According to one embodiment, the keratin protein includes at least about 10.0% w/w nitrogen. According to one embodiment, the keratin protein includes at least about 12.0% w/w nitrogen. According to one embodiment, the keratin protein includes at least about 14.0% w/w nitrogen. According to one embodiment, the keratin protein includes at least about 15.0% w/w nitrogen. According to one embodiment, the keratin protein includes at least about 16.0% w/w nitrogen. According to one embodiment, the keratin protein includes at least about 5.0% w/w to about 20.0% w/w nitrogen. According to one embodiment, the keratin protein includes at least about 10.0% w/w to about 18.0% w/w nitrogen. According to one embodiment, the keratin protein includes at least about 12.0% w/w to about 17.0% w/w nitrogen.

According to one embodiment, the keratin protein includes at least about 0.01% w/w phosphorus. According to one embodiment, the keratin protein includes at least about 0.05% w/w phosphorus. According to one embodiment, the keratin protein includes at least about 0.1% w/w phosphorus. According to one embodiment, the keratin protein includes at least about 0.5% w/w phosphorus. According to one embodiment, the keratin protein includes at least about 1.0% w/w phosphorus. According to one embodiment, the keratin protein includes at least about 1.5% w/w phosphorus. According to one embodiment, the keratin protein includes at least about 2.0% w/w phosphorus. According to one embodiment, the keratin protein includes at least about 2.5% w/w phosphorus. According to one embodiment, the keratin protein includes at least about 3.0% w/w phosphorus. According to one embodiment, the keratin protein includes at least about 3.5% w/w phosphorus. According to one embodiment, the keratin protein includes at least about 4.0% w/w phosphorus. According to one embodiment, the keratin protein includes at least about 4.5% w/w phosphorus. According to one embodiment, the keratin protein includes at least about 5.0% w/w phosphorus. According to one embodiment, the keratin protein includes from about 0.01% w/w to about 5.0% w/w phosphorus.

According to one embodiment, the keratin protein includes at least about 0.1% w/w potassium. According to one embodiment, the keratin protein includes at least about 1.0% w/w potassium. According to one embodiment, the keratin protein includes at least about 2.0% w/w potassium. According to one embodiment, the keratin protein includes at least about 3.0% w/w potassium. According to one embodiment, the keratin protein includes at least about 4.0% w/w potassium. According to one embodiment, the keratin protein includes at least about 5.0% w/w potassium. According to one embodiment, the keratin protein includes at least about 6.0% w/w potassium. According to one embodiment, the keratin protein includes at least about 7.0% w/w potassium. According to one embodiment, the keratin protein includes at least about 8.0% w/w potassium. According to one embodiment, the keratin protein includes at least about 9.0% w/w potassium. According to one embodiment, the keratin protein includes at least about 10.0% w/w potassium. According to one embodiment, the keratin protein includes from about 0.1% w/w potassium to about 10.0% w/w potassium.

### Carrier and Additional Components

According to one embodiment, the agricultural compositions as provided herein include at least one carrier. The carrier includes any biodegradable liquid that aids in the flowable or liquid nature of the final formulation and delivery of the at least one keratin protein to a target destination. According to a particular embodiment, the carrier includes water. The water may be subject to reverse osmosis or deionized prior to use in the agricultural compositions as a carrier.

According to one embodiment, the agricultural compositions as provided herein may further include at least one additional component as provided herein. Particularly suitable additional components include, but are not limited to, any biodegradable compound that aids in the function of the keratin protein, provide nutrients, or stimulates microbial action in an agricultural setting. Suitable additional components include beneficial and biodegradable nutrients or microbes. Other suitable additional components include citric acid, potassium hydroxide, cocodimethylamine, polyoxyethylene sorbitan monolaurate (commercially available as Tween™ 21), at least one emulsifier compound, at least one antifoaming compound, at least one antimicrobial agent, at least one buffer, at least one corrosion inhibitor, at least one dispersing agent, at least one dye, at least one fragrant, at least one freezing point depressant, at least one neutralizing agent, at least one odorant, at least one penetration aid, at least one sequestering agent, at least one spray drift control agent, at least one spreading agent, at least one stabilizer, at least one sticking agent, at least one viscosity-modifying additive, at least one preservative, at least one plasticizer, at least one hydrophobic barrier, at least one UV protectant, at least one water soluble solvent, or any combination thereof.

### Formulations

According to one embodiment, the agricultural compositions as provided herein are formulated as a flowable composition. According to one embodiment, the agricultural compositions as provided herein are formulated as a liquid. According to one embodiment, the agricultural compositions as provided herein are formulated as a slurry.

According to one embodiment, the agricultural compositions as provided herein are formulated as ready-to-use formulation. The ready-to-use formulation may be immediately used as described herein without any mixing or dilution. The ready-to-use formulation may be stored in a delivery device such as a spray bottle until use. The ready-to-use formulation is particularly suitable for indoor or decorative plants and trees as well as outdoor individual plants and trees.

According to one embodiment, the agricultural compositions as provided herein are formulated as an concentrate. The concentrate formulation may be mixed with or otherwise diluted with water, spray oil, or a combination thereof at the time of use.

According to one embodiment, the agricultural compositions as provided herein may also be formulated as an emulsifiable concentrate formulation, aqueous suspension concentrate (suspension concentrate), emulsion in water formulation, oil dispersion, or concentrated aqueous solution.

### Methods of Production

A method of producing an agricultural composition is provided. According to one embodiment, the method includes the step of providing a keratin protein source as provided herein. According to one embodiment, the method includes the step of washing the keratin protein source. The step of washing may include applying water to the keratin protein source. The water may be provided via reverse osmosis or may be deionized water. The water may be present at about 5% w/w (ratio of about 5 parts keratin protein source to 95 parts water). The step of washing may include agitating the protein source in the presence of water.

According to one embodiment, the method of producing an agricultural composition includes the step of extracting or lifting the keratin source cuticle thereby enabling release of one or more keratin proteins. The step of extracting or lifting the keratin protein may be accomplished by oxidation or reduction reactions of the keratin protein source by which the crosslinked structure of keratin source is broken down. According to one embodiment, the disulfide bonds in cystine amino acid residues are cleaved, rendering one or more keratin proteins within the keratin protein source soluble.

According to one embodiment, the one or more keratin proteins trapped in the keratin source (e.g., inside the cuticle's protective structure of hair) may be released by oxidatively reacting a denaturing solution with the rinsed keratin protein source to form an acid mixture. Suitable denaturing solutions include urea, transition metal hydroxides, surfactant solutions, and combinations thereof. Common methods utilize aqueous solutions of tris base (2-Amino-2-(hydroxymethyl)-1,3-propanediol) in concentrations between 0.1 and 1.0 M, and urea solutions between 0.1 and 10 M. According to one embodiment, the denaturing solution may be peracetic acid that is present at a concentration of from about 0.1 M to about 0.15 M.

According to one embodiment, the method of producing an agricultural composition includes the step of heating the acid mixture to about 40° C.-45° C. to form a heated acid mixture. According to one embodiment, the method of producing an agricultural composition includes the step of incubating the heated acid mixture for about 15 hours to about 18 hours to form an incubated acid mixture. According to one embodiment, the method of producing an agricultural composition includes the step of removing the peracetic acid from the incubated acid mixture to form an oxidized keratin protein source. The peracetic acid may be removed by rising the keratin protein source with water.

According to one embodiment, the method of producing an agricultural composition includes the step of treating the oxidized keratin protein source with 0.1 M-0.15 M tris(hydroxymethyl)aminomethane to form a disassociated keratin protein. According to one embodiment, the method of producing an agricultural composition includes the step of incubating the disassociated keratin protein at about 40° C.-45° C. for about 2 hours to about 4 hours to form a keratin protein slurry. According to one embodiment, the method of producing an agricultural composition includes the step of mixing water with the keratin protein slurry to form an agricultural composition.

### Methods of Application

According to one embodiment, the agricultural compositions provided herein may be applied to plant soil. According to one embodiment, the agricultural compositions provided herein may be applied below the soil surface or on top of the soil surface. According to one embodiment, the agricultural compositions provided herein may be mixed with a growth medium such as top soil or potting soil.

According to one embodiment, the agricultural compositions provided herein may be applied to an exposed plant surface. According to one embodiment, the agricultural compositions provided herein may be applied to a plant root. According to one embodiment, the agricultural compositions provided herein may be applied at or near a plant root.

A method of increasing yield of a crop is provided. The method includes the step of applying an agricultural composition to the surface of the at least one plant, the surrounding soil, turf, seed, or a combination thereof.

A method of improving the quality or health of at least one target plant is provided. The method includes the step of applying an agricultural composition to the surface of the at least one plant, the surrounding soil, turf, seed, or a combination thereof.

A method of increasing crop yield is provided. The method includes the step of applying an agricultural composition to the surface of the at least one plant, the surrounding soil, turf, seed, or a combination thereof.

A method of stimulating seed germination is provided. The method includes the step of applying an agricultural composition to the surface of the at least one plant, the surrounding soil, turf, seed, or a combination thereof.

A method of deterring pest from a plant is provided. The method includes the step of applying an agricultural composition to the surface of the at least one plant, the surrounding soil, turf, seed, or a combination thereof.

A method of increasing moisture retention for a plant is provided. The method includes the step of applying an agricultural composition to the surface of the at least one plant, the surrounding soil, turf, seed, or a combination thereof.

According to one embodiment, the agricultural compositions as provided herein may be added to a spray tank such that a stable tank mix composition is formed when the agricultural composition and any other additional optional ingredients, such as water or spray oil, are combined in the spray tank. The tank mix composition may be applied directly to a target plant or pest. The tank mix agricultural composition is particularly suited for direct application to at least one crop plant, the surrounding soil, turf, seed, or a combination thereof. According to one embodiment, the tank mix agricultural compositions as provided herein may be applied via a sprayer attached to a tank.

According to one embodiment, the agricultural compositions as provided herein may be applied via an irrigation system (chemigation). According to one embodiment, the agricultural compositions as provided herein may be applied as a drench treatment. According to one embodiment, the agricultural compositions as provided herein may be applied as a wick system.

According to a particular embodiment, the agricultural composition is applied at an effective rate of typically about 1.0 gallon (25% w/w keratin protein)/acre. According to a particular embodiment, the agricultural composition is applied at an effective rate of typically about 2.0 gallons (25% w/w keratin protein)/acre. According to a particular embodiment, the agricultural composition is applied at an effective rate of typically about 3.0 gallons (25% w/w keratin protein)/acre. According to a particular embodiment, the agricultural composition is applied at an effective rate of typically about 4.0 gallons (25% w/w keratin protein)/acre. According to a particular embodiment, the agricultural composition is applied at an effective rate of typically about 5.0 gallons (25% w/w keratin protein)/acre.

According to a particular embodiment, the agricultural composition is applied at an effective rate of typically about 1.0 gallon (25% w/w keratin protein)/acre to about 10.0 gallons (25% w/w keratin protein)/acre. According to a particular embodiment, the agricultural composition is applied at an effective rate of typically about 2.0 gallons (25% w/w keratin protein)/acre to about 9.0 gallons (25% w/w keratin protein)/acre. According to a particular embodiment, the agricultural composition is applied at an effective rate of typically about 3.0 gallons (25% w/w keratin protein)/acre to about 7.0 gallons (25% w/w keratin protein)/acre. According to a particular embodiment, the agricultural composition is applied at an effective rate of typically about 4.0 gallons (25% w/w keratin protein)/acre to about 8.0 gallons (25% w/w keratin protein)/acre.

### Methods of Use

The agricultural compositions provided herein stimulate and increase healthy plant growth and improve or enhance the health and performance of plants. Such plants include agricultural, home and garden plants. By improving the health and performance of plants, the resulting flowers, fruits, vegetable, legumes or similar target growth items may appear at an accelerated pace, appear healthier (e.g., higher quality plant) and have increased yield. According to one embodiment, the agricultural compositions provided herein stimulate and otherwise increase plant growth or plant height by at least about 5%, 10%, 15%, 20%, 25% or more. According to one embodiment, the agricultural compositions provided herein stimulate and otherwise increase crop yield by at least about 5%, 10%, 15%, 20%, 25%, 30%, 35%, 40%, 45%, 50%, 55%, 60%, 65%, 70%, 75%, 80%, 85%, 90%, 95%, or more.

The agricultural compositions provided herein stimulate stem diameter, stimulate root length and increase final harvest plant weight. Stem and root length contributes to improved and more efficient water utilization as well as overall robustness and vigor of the plant. According to one embodiment, the agricultural compositions provided herein increase stem diameter by at least about 15%, 25%, 35%, 45%, 50% or more. According to one embodiment, the agricultural compositions provided herein increase plant weight by at least about 5%, 10%, 15%, 20%, 25%, 35%, 40%, 45%, 50%, 55%, 60%, 65%, 70%, 75%, 80%, 85%, 90%, 95% or more. According to one embodiment, the agricultural compositions provided herein increase plant root length by at least about 5%, 10%, 15%, 20%, 25%, 30%, 35%, 40%, 45% or more.

The agricultural compositions as provided herein are suitable for promoting seed germination. According to such an embodiment, the agricultural compositions may be introduced to a seed prior to or at the point of planting.

The agricultural compositions as provided herein are suitable for promoting spot growth on existing plantings. According to such an embodiment, the agricultural compositions may be introduced to a plant locus.

The agricultural compositions as provided herein are suitable for deterring pests. According to such an embodiment, the agricultural compositions may be introduced to a plant locus or surrounding soil after planting. Pests subject to determent include, but are not limited to, any animal that is deemed detrimental to plant health. Such pests include mammals (deer, rabbit, raccoon, squirrel, or boar/pig), reptiles, or insects.

The agricultural compositions as provided herein may serve simultaneously as both an active and passive fertilizer as well as a herbicide. According to such an embodiment, the agricultural compositions may slowly release any nutrients into the soil surrounding a plant thereby providing both active and passive fertilization to a target plant.

The agricultural compositions as provided herein may act as or contribute to a natural weed barrier as well as provide a means of weed control (e.g., preventing weed growth). According to such an embodiment, the agricultural compositions may be introduced to the soil surrounding a plant.

### Agricultural Device

According to one embodiment, the agricultural compositions provided herein may be mixed with, soaked/introduced in or otherwise used in conjunction with a multi-function horticultural device to form an agricultural device. The multi-function horticultural device includes the device as set forth in U.S. Pat. No. 8,281,516, the contents of which are incorporated herein by reference in its entirety. The multi-function horticultural device includes a plurality of individual natural fibers intertwined such that the device has a density from generally about 0.02 to generally about 3 grams of individual natural fibers per cubic inch. The device is capable of holding and retaining from generally about 0.02 to generally about 15 grams of liquid or agricultural composition per cubic inch. The device may be generally homogeneous.

According to one embodiment, the multi-function horticultural device portion of the agricultural device includes at least one natural fiber from the group including human hair, animal hair, coconut fiber, seaweed, kelp, cotton, corn silk and peat moss. According to one embodiment, the plurality of individual natural fibers are intertwined by needle punching. According to one embodiment, the multi-function horticultural device is formed into a shape from the group including a generally rectangular planar mat, a generally rectangular solid, a disk, and a generally circular cylinder, depending on its intended usage. According to one embodiment, the multi-function horticultural device further includes a plurality of man-made fibers. According to one embodiment, the plurality of individual natural fibers may be formed into any pre-defined three-dimensional shape, intertwined by hydro-entangling, or formed into any pre-defined three-dimensional shape such as a rectangle, disk, or circular cylinder. According to one embodiment, the accumulation of natural fibers are intertwined using aero-entanglement. According to one embodiment, the plurality of individual natural fibers may be formed into any pre-defined three-dimensional shape.

According to one embodiment, the agricultural device is capable of both passively and actively fertilizing a plant with which it is associated and wherein such passive fertilization is the result of the device's biodegradation and microbial action. According to one embodiment, the agricultural device serves to reduce the growth and propagation of weeds in ground covered with the device. According to one embodiment, the agricultural device serves to inhibit the activity of pests from the general area of a plant with which the device is associated. According to one embodiment, the agricultural device serves to reduce the watering needs of a planting with which it is associated through its moisture retention capability. According to one embodiment, the agricultural device

[symbol]

According to one embodiment, an agricultural composition as provided herein may be applied to a soil surface, applied below a soil surface or mixed with soil surrounding a plant prior to application of the multi-function horticultural device over the soil surface containing the agricultural composition.

Although specific embodiments of the present invention are herein illustrated and described in detail, the invention is not limited thereto. The above detailed descriptions are provided as exemplary of the present invention and should not be construed as constituting any limitation of the invention. Modifications will be apparent to those skilled in the art, and all modifications that do not depart from the spirit of the invention are intended to be included with the scope of the appended claims.

### EXAMPLE 1

### Basil Plant Height, Root Length and Whole Plant Partitioning Improvement

Greenhouse-grown basil were planted in containers filled with soil-less potting mix at the rate of one plant per container. The plants were maintained moisture-stress-free by using a drip irrigation method. Treatments were applied at biweekly intervals. Each treatment comprised of five single potted plants per treatment within each replication. Plant height was recorded biweekly. The objectives were to determine any changes with time in the plant growth of basil plants in response to treatments and impact on growth and yield of basil. The treatments evaluated and application rates are set forth in Table 1.

TABLE 1

| | | Application |
|---|---|---|
| | | Rate/ |
| Treatment | Composition | Treatment |
| Control | No application of any | N/A |
| | fertilizer | |
| Neptune's Harvest ™ | Fish emulsion-based | 10 ounces |
| Fertilizer (commercial | commercial organic soluble | |
| fertilizer) | fertilizer | |
| Agricultural Composition #1 | 10% w/w keratin protein | 10 ounces |
| Agricultural Composition #2 | 20% w/w keratin protein | 10 ounces |

TABLE 2

| | | Neptune's | | |
|---|---|---|---|---|
| | | Harvest ™ | | |
| | | Fertilizer | | |
| | | (commercial | Agricultural | Agricultural |
| Days After | Control | fertilizer) | Composition #1 | Composition #2 |
| Treatment | Height (cm) | Height (cm) | Height (cm) | Height (cm) |
| 7 | 24.4 | 24.4 | 25.5 | 26 |
| 15 | 28.8 | 28.9 | 29.2 | 29.2 |
| 29 | 28.5 | 27.8 | 32.2 | 34.8 |
| 36 | 30.3 | 30.4 | 34.4 | 35.7 |
| 43 | 32.6 | 33.0 | 35.8 | 40.1 |
| 50 | 36.4 | 36.6 | 39.2 | 42.6 |
| 57 | 39.4 | 39.8 | 40.1 | 45.4 |
| 66 | 40.5 | 41.1 | 41.1 | 47.6 |

### Plant Height

Treatment effects on plant height were assessed by measuring plant height at day 66 as a function of time and the number of branches per plant at the final harvest. Plant height, measured at weekly intervals from the date of planting to final harvest, increased with time in all the treatments. Plants in all treatments grew slowly for about 30 days after planting.

Agricultural Composition #2 resulted in 7% greater height of basil compared to Agricultural Composition #1 and the commercial fertilizer. Each of Agricultural Composition #1 and the commercial fertilizer resulted in 10% greater height than did the Control.

### Root Length

Agricultural Composition #2 resulted in 24% greater root length compared to Agricultural Composition #1 and the commercial fertilizer. Each of Agricultural Composition #1 and the commercial fertilizer produced a basil root length 45% greater than the Control.

### Leaf and Stem Fresh Weight

Agricultural Composition #2 resulted in fresh leaf weight of 81.8 g/plant) and was statistically significantly greater than that of other treatments. Plants treated with the commercial fertilizer resulted in 50.2 g/plant of fresh leaf, whereas the plants treated with Agricultural Composition #1 and Control produced 36.1 and 32.5 g/Plant, respectively.

### Dry Matter Partitioning

With regard to whole plant weight partitioning, Agricultural Composition #2 resulted in 33% greater weight partitioning compared to Agricultural Composition #1 and the commercial fertilizer. Each of Agricultural Composition #1 and the commercial fertilizer resulted in whole plant weight partitioning of 50% greater than the Control.

### Conclusion

In conclusion, Agricultural Composition #2 had significant effects on plant growth and biomass production. The application of Agricultural Composition #2 increased the number of branches per plant over the Control, enabled plants to produce significantly longer roots, and produced more fresh leaf and stem biomass over the control plants.

### EXAMPLE 2

Experiments were conducted to evaluate how application of chicken manure and an Agricultural Composition (25% w/w keratin protein) impacted various performance indicators on established soybean plants (initially about 4 inches tall). A single control treatment of commercially available (ready-to-use) Chicken Manure was prepared and applied to one acre of the soybean plants at a rate of one gallon per acre. A single agricultural composition (25% w/w keratin protein) was prepared and applied to one acre of soybean plants at a rate of 5 gallons per acre.

Measurements of plant weight and stem diameter were taken 30 days after treatment. The results are provided in Table 3.

TABLE 3

| Treatment | Stem Diameter | Plant Weight |
|---|---|---|
| Chicken Manure | 6.9 mm | 11.7 oz |
| Agricultural Composition | 12.1 mm | 18.46 oz |
| (25% w/w keratin protein) | | |

At day 60 after treatment, samples of three soybean plants treated with chicken manure and samples of three soybean plants treated with the Agricultural Composition were harvested. The plant height, stem diameter and three-plant weight are provided reported in Table 4.

TABLE 4

| | Plant | | |
|---|---|---|---|
| | Height | Stem Diameter | Three Plant |
| Treatment | (inch) | (inch) | Weight (grams) |
| Chicken Manure | 43 | 5/16, 4/16, 3/17 | 436 |
| Chicken Manure | 34 | 4/16, 4/16, 5/16 | 318 |
| Chicken Manure | 37 | 6/16, 5/16, 4/16 | 618 |
| Chicken Manure | 32 | 4/16, 5/16, 5/16 | 462 |
| Chicken Manure | 32 | 5/16, 4/16, 5/16 | 397 |
| Agricultural Composition | 38 | 8/16, 9/16, 10/16 | 1213 |
| Agricultural Composition | 39 | 5/16, 7/16, 5/16 | 665 |
| Agricultural Composition | 37 | 7/16, 6/16, 9/16 | 579 |
| Agricultural Composition | 39 | 5/16, 6/16, 5/16 | 484 |
| Agricultural Composition | 43 | 7/16, 8/16, 9/16 | 615 |

Plants treated with chicken manure had an average height of 33.75 inches. Plants treated with the Agricultural Composition had an average height of 39.2. Thus, plants treated with the Agricultural Composition showed a 16% increase in height compared to plants treated with chicken manure.

Plants treated with chicken manure had an average stem diameter of 0.29 inches. Plants treated with the Agricultural Composition had an average stem diameter of 0.44 inches. Thus, plants treated with the Agricultural Composition showed a 52% increase in stem diameter compared to plants treated with chicken manure.

Plants treated with chicken manure had an average three plant weight of 448.75 grams. Plants treated with the Agricultural Composition had an average three plant weight of 711.2 grams. Thus, plants treated with the Agricultural Composition showed a 58% increase in three plant weight compared to plants treated with chicken manure.

Additionally, plants treated with chicken manure produced an average of 131 soybean pods and an average weight of 181 grams while soybean plants treated with chicken manure produced an average of 263 soybean pods and an average weight of 348 grams. Thus, treatment with the Agricultural Composition provided a 101% pod increase and a 92% in average plant weight compared to the chicken manure.

At day 108 after treatment, samples of five plants treated with chicken manure and samples of five soybean plants treated with the Agricultural Composition were harvested. The number of pods, pod weight and five-plant weight are provided in Table 5.

TABLE 5

| | Number of | Pods Weight | Soybean Weight |
|---|---|---|---|
| | Pods | from 5 | from 5 Plants |
| Sample type | from 5 plants | plants | (grams) |
| Chicken Manure | 199 | 117.00 | 94 |
| Chicken Manure | 180 | 94 | 77 |
| Chicken Manure | 249 | 136 | 111 |
| Chicken Manure | 246 | 120 | 98 |
| Chicken Manure | 141 | 78 | 65 |
| Agricultural Composition | 232 | 125 | 102 |
| Agricultural Composition | 193 | 108 | 90 |
| Agricultural Composition | 251 | 133 | 104 |
| Agricultural Composition | 243 | 130 | 105 |
| Agricultural Composition | 253 | 141 | 114 |

Plants treated with chicken manure produced an average of 203 soybean pods, an average pod weight of 109 grams, and an average five plant weight 89 grams. Plants treated with the Agricultural Composition produced an average of 234.4 soybean pods, an average pod weight of 127.4 grams, and an average soybean plant weight of 103 grams.

Thus, treatment with the Agricultural Composition provided a 15% pod increase, a 17% increase in pod weight and a 16% increase in average plant weight compared to the chicken manure treatment.

### GENERAL STATEMENTS

The following statements provide a general description of the disclosure and are not intended to limit the appended claims.

Statement 1. An agricultural composition is provided that includes at least one keratin protein and at least one carrier.

Statement 2. An agricultural composition is provided according to Statement 1, wherein the at least one keratin protein includes from about 5.0% w/w to about 20.0% w/w nitrogen, from about 0.01% w/w to about 5.0% w/w phosphorus, and from about 0.1% w/w potassium to about 10.0% w/w potassium.

Statement 3. An agricultural composition is provided according to Statements 1-2, wherein the keratin protein is isolated from human hair.

Statement 4. An agricultural composition is provided according to Statements 1-3, wherein the carrier comprises water.

Statement 5. An agricultural composition is provided according to Statements 1-4, comprising: from about 5.0% w/w to about 25.0% w/w of the at least one keratin protein; and from about 75% w/w to about 95% w/w of the at least one carrier.

Statement 6. An agricultural composition is provided according to Statements 1-5, wherein the at least one keratin protein comprises from about 10% w/w to about 20% w/w nitrogen.

Statement 7. An agricultural composition is provided according to Statements 1-6, wherein upon application to a plant, the plant growth or plant height is increased by at least about 5%, 10%, 15%, 20%, 25% or more.

Statement 8. An agricultural composition is provided according to Statements 1-6, wherein upon application to a plant, the stem diameter is increased by at least about 15%, 25%, 35%, 45%, 50% or more.

Statement 9. An agricultural composition is provided according to Statements 1-6, wherein upon application to a plant, the plant weight is increased by at least about 5%, 10%, 15%, 20%, 25% or more.

Statement 10. An agricultural composition is provided according to Statements 1-6, wherein upon application to a plant, the plant roots are increased by at least about 5%, 10%, 15%, 20%, 25%, 30%, 35%, 40%, 45% or more.

Statement 11. An agricultural device is provided that includes an agricultural composition of Statements 1-6 and a multi-function horticultural device including plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.

Statement 12. An agricultural device is provided according to Statement 11, wherein the multi-function horticultural device includes at least one natural fiber from the group including human hair, animal hair, coconut fiber, seaweed, kelp, cotton, corn silk and peat moss.

Statement 13. An agricultural device is provided according to Statements 11-12, wherein the multi-function horticultural device includes a plurality of individual natural fibers that may be intertwined by needle punching.

Statement 14. An agricultural device is provided according to Statements 11-13, wherein the multi-function horticultural device is formed into a shape from the group including a generally rectangular planar mat, a generally rectangular solid, a disk, and a generally circular cylinder, depending on its intended usage.

Statement 15. An agricultural device is provided according to Statements 11-14, wherein the multi-function horticultural device further comprises a plurality of man-made fibers.

Statement 16. An agricultural device is provided according to Statements 11-15, wherein the multi-function horticultural device includes a plurality of individual natural fibers that may be formed into any pre-defined three-dimensional shape.

Statement 17. An agricultural device is provided according to Statements 11-16, wherein the multi-function horticultural device includes a plurality of individual natural fibers that may be intertwined by hydro-entangling.

Statement 18. An agricultural device is provided according to Statements 11-17, wherein the multi-function horticultural device is formed into a shape from the group including a generally rectangular planar mat, a generally rectangular solid, a disk, and a generally circular cylinder, depending on its intended usage.

Statement 19. An agricultural device is provided according to Statements 11-18, wherein the accumulation of natural fibers are intertwined using aero-entanglement.

Statement 20. An agricultural device is provided according to Statements 11-19, wherein the device is capable of both passively and actively fertilizing a plant with which it is associated and wherein such passive fertilization is the result of the device's biodegradation and microbial action.

Statement 21. An agricultural device is provided according to Statements 11-20, wherein the device serves to reduce the growth and propagation of weeds in ground covered with the device.

Statement 22. An agricultural device is provided according to Statements 11-21, wherein the device serves to inhibit the activity of pests from the general area of a plant with which the device is associated.

Statement 23. An agricultural device is provided according to Statements 11-22, wherein the device serves to reduce the watering needs of a planting with which it is associated through its moisture retention capability.

Statement 24. A method for stimulating root development is provided that includes the step of applying an agricultural composition of Statements 11-23 or agricultural device of Statements 1-10 to the surface of the at least one plant, the surrounding soil, turf, seed, or a combination thereof.

Statement 25. A method of improving the quality or health of at least one target plant is provided that includes the step of applying an agricultural composition of Statements 11-23 or agricultural device of Statements 1-10 to the surface of the at least one plant, the surrounding soil, turf, seed, or a combination thereof.

Statement 26. A method of increasing crop yield is provided that includes the step of applying an agricultural composition Statements 11-23 or agricultural device of Statements 1-10 to the surface of the at least one plant, the surrounding soil, turf, seed, or a combination thereof.

Statement 27. A method of deterring pests from a plant is provided that includes the step of applying an agricultural composition of Statements 11-23 or agricultural device of Statements 1-10 to the surface of the at least one plant, the surrounding soil, turf, seed, or a combination thereof.

Statement 28. A method of increasing moisture retention for a plant is provided that includes the step of applying an agricultural composition of Statements 11-23 or agricultural device of Statements 1-10 to the surface of the at least one plant, the surrounding soil, turf, seed, or a combination thereof.

What is claimed is:

1. An agricultural composition comprising:
at least one keratin protein comprising:
from about 5.0% w/w to about 20.0% w/w nitrogen;
from about 0.01% w/w to about 5.0% w/w phosphorus; and
from about 0.1% w/w to about 10.0% w/w potassium; and
at least one carrier.

2. The agricultural composition of claim 1, wherein the keratin protein is isolated from human hair.

3. The agricultural composition of claim 1, wherein the carrier comprises water.

4. The agricultural composition of claim 1, comprising:
from about 5.0% w/w to about 25.0% w/w of the at least one keratin protein; and
from about 75% w/w to about 95% w/w of the at least one carrier.

5. The agricultural composition of claim 4, wherein the at least one keratin protein comprises from about 10% w/w to about 20% w/w nitrogen.

6. The agricultural composition of claim 1, wherein upon application to a plant, the plant growth is increased by at least about 15%.

7. An agricultural device comprising:
an agricultural composition comprising:
at least one keratin protein comprising:
from about 5% w/w to about 20% nitrogen;
from about 0.01% w/w to about 5.0% w/w phosphorus; and
from about 0.1% w/w potassium to about 10.0% w/w potassium; and
at least one carrier; and
a multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.

8. The agricultural device of claim 7, wherein the multi-function horticultural device includes at least one natural fiber from the group including human hair, animal hair, coconut fiber, seaweed, kelp, cotton, corn silk and peat moss.

9. The agricultural device of claim 7, wherein the multi-function horticultural device further comprises a plurality of man-made fibers.

10. The agricultural device of claim 7, wherein the agricultural composition comprises:
from about 5.0% w/w to about 25.0% w/w of the at least one keratin protein; and
from about 75% w/w to about 95% w/w of the at least one carrier.

11. A method for stimulating root development of a plant, the method including the step of applying the agricultural composition of claim 1 to a surface of the plant, surrounding soil, turf, seed, or a combination thereof.

12. The method of claim 11, further comprising the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.

13. A method of improving the quality or health of at least one target plant, the method including the step of applying the agricultural composition claim 1 to a surface of the at least one plant, the surrounding soil, turf, seed, or a combination thereof.

14. The method of claim 13, further comprising the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.

15. A method of increasing crop yield of at least one plant, the method including the step of applying the agricultural composition of claim 1 to the surface of the at least one plant, the surrounding soil, turf, seed, or a combination thereof.

16. The method of claim 15, further comprising the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.

17. A method of deterring pests from at least one plant, the method including the step of applying the agricultural composition of claim 1 to the surface of the at least one plant, the surrounding soil, turf, seed, or a combination thereof.

18. The method of claim 17, further comprising the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.

19. A method of increasing moisture retention for at least one plant, the method including the step of applying the agricultural composition of claim 1 to the surface of the at least one plant, the surrounding soil, turf, seed, or a combination thereof.

20. The method of claim 19, further comprising the step of introducing a multi-function horticultural device to the surrounding soil that has the agricultural composition applied thereto, the multi-function horticultural device comprising a plurality of individual natural fibers intertwined such that the multi-function horticultural device has a density from generally about 0.02 to generally about 3 grams of the individual natural fibers per cubic inch, wherein the multi-function horticultural device is capable of holding and retaining from generally about 0.02 to generally about 15 grams of liquid per cubic inch and wherein the multi-function horticultural device is generally homogeneous.
